(19) United States
(12) Patent Application Publication
(10) Pub. No.: US 2013/0059579 A1
(43) Pub. Date: Mar. 7, 2013

(54) MOBILE TERMINAL AND MOBILE COMMUNICATION METHOD

(71) Applicants: Nobukazu Uno, Tokyo (JP); Shinya Takeda, Tokyo (JP)

(72) Inventors: Nobukazu Uno, Tokyo (JP); Shinya Takeda, Tokyo (JP)

(73) Assignee: NTT DOCOMO ,INC., Tokyo (JP)

(21) Appl. No.: 13/637,625

(22) PCT Filed: Mar. 30, 2011
(86) PCT No.: PCT/JP2011/057948

§ 371 Date: Nov. 15, 2012

(30) Foreign Application Priority Data
Mar. 31, 2010 (JP) 2010-081836

(51) Int. Cl. H04W 24/10

(52) U.S. Cl. 455/434

(57) ABSTRACT

The present invention allows a mobile terminal which recognizes a UMTS cell as a serving cell to display that the mobile terminal is in the coverage of an LTE cell near the serving cell on a standby screen without performing any cell search of the LTE cell. In an overlapping area between the UMTS cell and the LTE cell, the mobile terminal of the present invention recognizes the UMTS cell as a serving cell which the mobile terminal camps on or is connected to, is provided with an estimation section that estimates that the mobile terminal is in the coverage of LTE cell, when received broadcast information includes an LTE cell detection identifier, and a display section that displays that the mobile terminal is in the coverage of LTE cell, when the estimation section estimates that the mobile terminal is in the coverage of LTE cell.

### TECHNICAL FIELD

The present invention relates to a mobile terminal and a mobile communication method that recognize, in an overlapping area between a first cell capable of communication using a first scheme and a second cell capable of communication using a second scheme, the first cell as a serving cell which the mobile terminal camps on or is connected to.

### BACKGROUND ART

In recent years, there is a growing overlapping area between a cell capable of communication using a UMTS (Universal Mobile Telecommunications System) scheme (hereinafter referred to as “UMTS cell”) and a cell capable of communication using an LTE (Long Term Evolution) scheme capable of downloading a large-volume content faster than the UMTS scheme (hereinafter referred to as “LTE cell”).

In such an overlapping area between the UMTS cell and LTE cell, it is a known fact that user convenience can be improved by appropriately displaying a cell in which the mobile terminal is located on a standby screen of the mobile terminal (e.g., Patent Literature 1).

### CITATION LIST

### Patent Literature

[Patent Literature 1] Japanese Patent Application Laid-Open No. 2010-28238

### SUMMARY OF INVENTION

### Technical Problem

However, according to the technique described in above-described Patent Literature 1, when a mobile terminal, which recognizes the UMTS cell as the serving cell, displays on its standby screen whether the mobile terminal is in the coverage of LTE cell, it is necessary to perform a cell search of the LTE cell.

For this reason, even when a radio environment of the UMTS cell which a mobile terminal camps on, is good and the serving cell need not be changed to the LTE cell, there is a problem that it is necessary to perform a cell search of the LTE cell only for the purpose of displaying that the terminal is in the coverage of LTE cell on the standby screen.

The present invention has been implemented in view of such a problem and it is an object of the present invention to provide a mobile terminal and a mobile communication method capable of displaying that the mobile terminal is in the coverage of LTE cell on a standby screen without performing a cell search of the LTE cell while camping on the UMTS cell.

### Solution to Problem

A mobile terminal according to a first aspect of the present invention is a mobile terminal configured to, in an overlapping area between a first cell capable of communication using a first scheme and a second cell capable of communication using a second scheme, recognize the first cell as a serving cell which the mobile terminal camps on or is connected to, including: a receiving section configured to receive broadcast information broadcast from a network-side apparatus of the first scheme; an estimation section configured to estimate that the mobile terminal is in a coverage of second cell, when the broadcast information received by the receiving section includes a second cell detection identifier; and a display section configured to display that the mobile terminal is in the coverage of second cell, when the estimation section estimates that the mobile terminal is in the coverage of second cell.

In this configuration, the mobile terminal which recognizes the first cell as the serving cell only determines whether or not the received broadcast information includes a second cell detection identifier, and can thereby display that it is in the coverage of second cell on a standby screen. Therefore, it is not necessary to perform a cell search of the second cell only for the purpose of displaying that it is in the coverage of second cell on the standby screen and it is possible to prevent increase in processing load or power consumption of the mobile terminal caused by the cell search.

The mobile terminal according to the first aspect further includes a priority determining section configured to determine priority of the first cell and the second cell, wherein when the priority determining section determines that the second cell has lower priority than the first cell and when the broadcast information received by the receiving section includes the second cell detection identifier, the estimation section is configured to estimate that the mobile terminal is in the coverage of second cell.

According to this configuration, when a radio environment of the first cell which is the serving cell is good and the serving cell need not be changed to the second cell, the mobile terminal which recognizes the first cell as the serving cell need not perform a cell search of the second cell which has lower priority than the first cell only for the purpose of displaying whether or not the mobile terminal is in the coverage of second cell on the standby screen, and can thereby reduce processing load or power consumption of the mobile terminal.

In the mobile terminal according to the first aspect, wherein when the priority determining section determines that the second cell has higher priority than the first cell and when the broadcast information received by the receiving section includes the second cell detection identifier, the estimation section is configured to estimate that the mobile terminal is in the coverage of second cell.

According to this configuration, when a radio environment of the first cell which is the serving cell is good and the serving cell need not be changed to the second cell, the mobile terminal which recognizes the first cell as the serving cell need not perform a cell search of the second cell which has higher priority than the first cell only for the purpose of displaying whether or not the mobile terminal is in the coverage of second cell on the standby screen, and can thereby reduce processing load or power consumption of the mobile terminal.

In the mobile terminal according to the first aspect, the receiving section is configured to receive not only the broadcast information but also dedicated priority information dedicatedly provided to the mobile terminal from the network-side apparatus of the first scheme, and when the receiving section receives the dedicated priority information in addition to the broadcast information, the priority determining section is configured to determine the priority of the first cell and the second cell in accordance with the dedicated priority information.

According to this configuration, even when the dedicated priority information is dedicatedly provided to the mobile terminal from the network-side apparatus of the first scheme, the mobile terminal can appropriately determine the priority of the first cell and the second cell.

In the mobile terminal according to the first aspect, when the priority determining section determines that the second cell has lower priority than the first cell in accordance with the dedicated priority information and even when the dedicated priority information includes the second cell detection identifier, if the broadcast information does not include the second cell detection identifier, the estimation section is configured to estimate that the mobile terminal is outside of the second cell.

According to this configuration, even when priority of the first cell and the second cell is provided by the dedicated priority information dedicatedly transmitted to the mobile terminal, it is possible to estimate whether or not the mobile terminal is in the coverage of second cell depending on whether or not the second cell detection identifier is included in the broadcast information appropriately updated according to the radio environment or network situation or the like. Therefore, it is possible to prevent the mobile terminal from being estimated to be in the coverage of second cell based on old dedicated priority information even when the mobile terminal has already moved to outside the second cell.

In the mobile terminal according to the first aspect, the broadcast information is an SIB (System Information Block Type) 19 and the second cell detection identifier is E-UTRA Detection set to TRUE.

A mobile communication method according to a second aspect of the present invention includes the steps of: by a mobile terminal configured to, in an overlapping area between a first cell capable of communication using a first scheme and a second cell capable of communication using a second scheme, recognize the first cell as a serving cell which the mobile terminal camps on, receiving broadcast information broadcast from a network-side apparatus of the first scheme; estimating that the mobile terminal is in the coverage of second cell, when the received broadcast information includes a second cell detection identifier; and displaying that the mobile terminal is in the coverage of second cell, when the mobile terminal is estimated to be in the coverage of second cell.

### Technical Advantages of the Invention

According to the present invention, it is possible to provide a mobile terminal and a mobile communication method capable of displaying that the mobile terminal is in the coverage of LTE cell on a standby screen without performing, in the mobile terminal which recognizes the UMTS cell as a serving cell, any cell search of the LTE cell while camping on the serving cell.

### BRIEF DESCRIPTION OF DRAWINGS

FIG. 1 is a configuration diagram of a mobile communication system according to a first embodiment of the present invention;

FIG. 2 is a function block diagram of the mobile terminal according to the first embodiment of the present invention;

FIG. 3 is a diagram illustrating a display screen of the mobile terminal according to the first embodiment of the present invention;

FIG. 4 is a flowchart illustrating operation of the mobile terminal according to the first embodiment of the present invention;

FIG. 5 is a flowchart illustrating operation of the mobile terminal according to the first embodiment of the present invention;

FIG. 6 is a diagram illustrating display control operation according to common priority information according to the first embodiment of the present invention; and

FIG. 7 is a diagram illustrating display control operation in accordance with dedicated priority information according to the first embodiment of the present invention.

### DESCRIPTION OF EMBODIMENTS

Hereinafter, an embodiment of the present invention will be described. Identical parts among descriptions in the accompanying drawings are assigned identical reference numerals.

### <Schematic Configuration of Mobile Communication System>

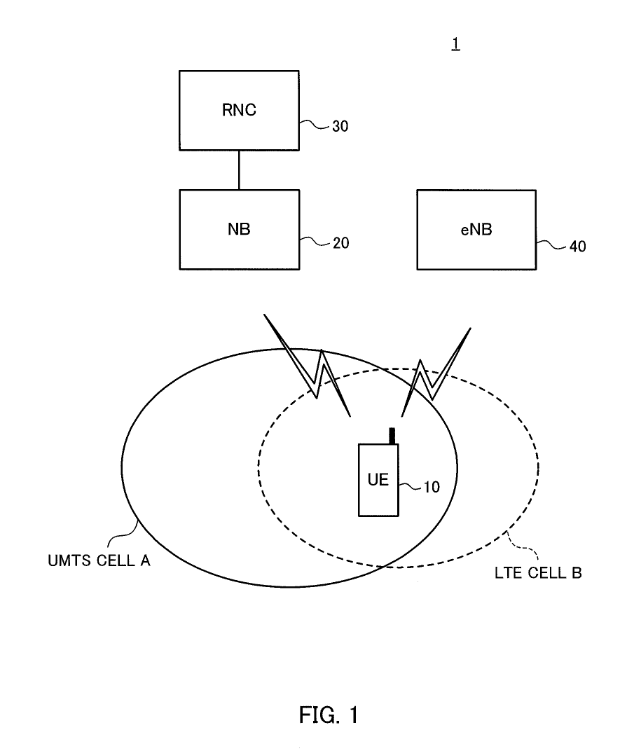

FIG. 1 is a diagram illustrating a schematic configuration of a mobile communication system according to a first embodiment of the present invention. As shown in FIG. 1, in a mobile communication system 1, a UMTS cell A (first cell) capable of communication using a UMTS scheme (first scheme) and an LTE cell B (second cell) capable of communication using an LTE scheme (second scheme) are arranged so as to partially geographically overlap each other. The UMTS cell A is not limited to a cell capable of communication using the UMTS scheme, but may also be a cell capable of communication using a communication scheme of an earlier generation than the communication scheme used in the LTE cell B. Furthermore, the LTE cell B is not limited to a cell capable of communication using the LTE scheme but may be a cell capable of communication using other 3.9th generation communication scheme or a fourth or later generation communication scheme such as LTE-Advanced scheme.

Furthermore, in the mobile communication system 1, a UE 10 which is a mobile terminal such as a mobile phone, notebook computer, and portable type game machine is configured to adaptively change a serving cell, which the UE 10 camps on or is connected to, to any one of the UMTS cell A and LTE cell B.

When the UE 10 recognizes the UMTS cell A as the serving cell, the UE 10 transmits/receives a control signal of RRC (Radio Resource Control) protocol to/from an RNC 30 (network-side apparatus) which is a radio control apparatus connected to an NB 20 (NodeB) which is a radio base station that forms the UMTS cell A via the NB 20. Furthermore, when UE 10 recognizes the LTE cell B as the serving cell, the UE 10 transmits/receives a control signal of RRC protocol to/from an eNB (eNodeB) 40 which is a radio base station that forms the LTE cell B.

The RNC 30 is configured to broadcast common priority information to the UE 10 which recognizes the UMTS cell A as the serving cell in the overlapping area between the UMTS cell A and LTE cell B. Here, the common priority information is included in broadcast information commonly broadcast to the UE 10 which recognizes the UMTS cell A as the serving cell and indicates the priority of the UMTS cell A and LTE cell B. For example, “SIB (System Information Block Type) 19” broadcast from the RNC 30 to the UE 10 is used as the broadcast information and “E-UTRA frequency and priority info list” included in “SIB19” is used as the common priority information.

Furthermore, the RNC 30 may also be configured to provide dedicated priority information to the UE 10 which recognizes the UMTS cell A as the serving cell in the overlapping area between the UMTS cell A and the LTE cell B. Here, the dedicated priority information is dedicatedly provided to the UE 10 which recognizes the UMTS cell A as the serving cell and indicates the priority of the UMTS cell A and the LTE cell B. For example, “Dedicated Priority Information” of “UTRAN Mobility Information” is used as the dedicated priority information.

Furthermore, in the overlapping area between the UMTS cell A and the LTE cell B, the RNC 30 broadcasts broadcast information including an LTE cell detection identifier to the UE 10 which recognizes the UMTS cell A as the serving cell. Here, the “LTE cell detection identifier” (second cell detection identifier) is an identifier indicating the presence of the LTE cell B that is geographically overlapping with or in proximity to the UMTS cell A. For example, “E-UTRA detection” set to “TRUE” is used as the LTE cell detection identifier.

“E-UTRA detection” used as the LTE cell detection identifier is an information element included in any one of “SIB19” and “UTRAN Mobility Information,” but as will be described later, the UE 10 estimates whether or not it is in the coverage of LTE cell depending on whether or not “E-UTRA detection” set to “TRUE” is included in “SIB19.”

### <Configuration of UE>

Next, the configuration of the UE 10 in the mobile communication system 1 will be described. The UE 10 has hardware including a communication interface, a processor, a memory, a display and an input key, and the memory stores software modules that are executed by the processor. The functional configuration of the UE 10 which will be described later may be realized by the above-described hardware or may be realized by software modules that are executed by the processor or may be realized by a combination of the two.

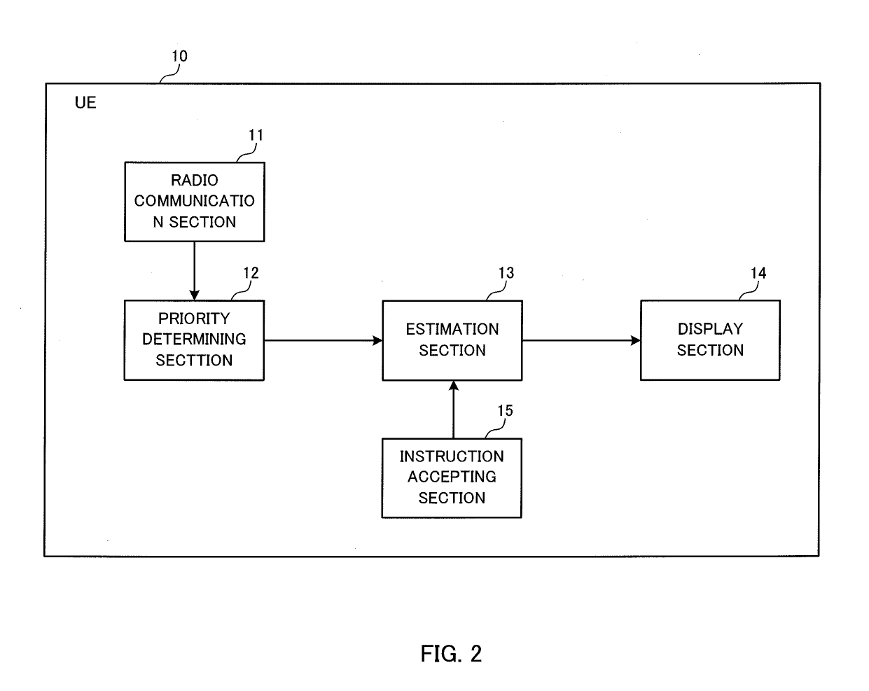

FIG. 2 is a functional configuration diagram of the UE according to a first embodiment of the present invention. As shown in FIG. 2, the UE 10 is provided with a radio communication section 11, a priority determining section 12, an estimation section 13, a display section 14 and an instruction accepting section 15.

When the UMTS cell A is recognized as the serving cell, the radio communication section 11 transmits/receives a radio signal to/from the NB 20. To be more specific, when the UMTS cell A is recognized as the serving cell, the radio communication section 11 (receiving section) receives broadcast information broadcast from the RNC 30. Furthermore, when the UMTS cell A is recognized as the serving cell, the radio communication section 11 may also receive dedicated priority information dedicatedly provided from the RNC 30 via the NB 20. The radio communication section 11 may also receive broadcast information broadcast from a network-side apparatus other than the RNC 30 or dedicated priority information provided from a network-side apparatus other than the RNC 30.

Furthermore, when the LTE cell B is recognized as the serving cell, the radio communication section 11 transmits/receives a radio signal to/from the eNB 40.

The priority determining section 12 determines the priority of the UMTS cell A and the LTE cell B. To be more specific, when the radio communication section 11 receives broadcast information including common priority information, the priority determining section 12 determines the priority of the UMTS cell A and the LTE cell B according to the common priority information. Furthermore, when the radio communication section 11 receives dedicated priority information in addition to the broadcast information including the common priority information, the priority determining section 12 determines the priority of the UMTS cell A and the LTE cell B in accordance with the dedicated priority information.

When the UMTS cell A is recognized as the serving cell, the estimation section 13 estimates whether or not the UE 10 is in the coverage of LTE cell B depending on whether or not the broadcast information received by the radio communication section 11 includes an LTE detection identifier in response to a request from the instruction accepting section 15 which will be described later. The estimation section 13 may also estimate whether or not the UE 10 is in the coverage of LTE cell B according to the reception of broadcast information by the radio communication section 11 even when there is no request from the instruction accepting section 15.

To be more specific, when the priority determining section 12 determines that the LTE cell B has lower priority than the UMTS cell A and the broadcast information received by the radio communication section 11 includes an LTE detection identifier, the estimation section 13 estimates that the UE 10 is in the coverage of LTE cell B without performing any cell search of the LTE cell B having lower priority than the UMTS cell A which is the serving cell. When, for example, “SIB19” received by the radio communication section 11 includes “E-UTRA detection” set to “TRUE”, the estimation section 13 estimates that the UE 10 is in the coverage of LTE cell B.

Furthermore, when the priority determining section 12 determines that the LTE cell B has lower priority than the UMTS cell A and the broadcast information received by the radio communication section 11 does not include any LTE detection identifier, the estimation section 13 may estimate that the UE 10 is not in the coverage of LTE cell B (that is, outside the cell) without performing any cell search of the LTE cell B having lower priority than the UMTS cell A which is the serving cell. When, for example, “SIB19” received by the radio communication section 11 includes “E-UTRA detection” set to “FALSE” or “SIB19” does not include the information element of “E-UTRA detection” itself, the estimation section 13 estimates that the UE 10 is outside of the LTE cell B. Furthermore, when SIB19 received by the radio communication section 11 does not include the information element of “E-UTRA frequency and priority info list” itself, the estimation section 13 may estimate that the UE 10 is outside of the LTE cell B.

Furthermore, when the priority determining section 12 determines that the LTE cell B has higher priority than the UMTS cell A and the broadcast information received by the radio communication section 11 includes an LTE detection identifier, the estimation section 13 may estimate that the UE 10 is in the coverage of LTE cell B without performing any cell search of the LTE cell B having higher priority than the UMTS cell A which is the serving cell.

Furthermore, when the priority determining section 12 determines that the LTE cell B has higher priority than the UMTS cell A and the broadcast information received by the radio communication section 11 does not include any LTE detection identifier, the estimation section 13 may estimate that the UE 10 is not in the coverage of LTE cell B (that is, outside the LTE cell B) without performing any cell search of the LTE cell B having higher priority than the UMTS cell A which is the serving cell.

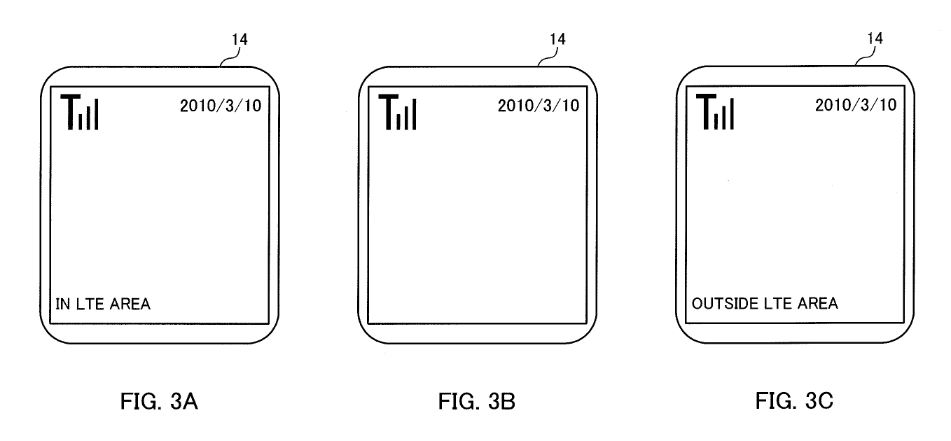

The display section 14 displays various display screens. FIG. 3 is a diagram illustrating the standby screen of the display section 14 according to the first embodiment. When the UMTS cell A is recognized as the serving cell and the estimation section 13 estimates that the UE 10 is in the coverage of LTE cell B, the display section 14 displays that the UE 10 is in the coverage of LTE cell B as shown, for example, in FIG. 3A.

Furthermore, when the UMTS cell A is recognized as the serving cell and the estimation section 13 estimates that the UE 10 is outside of the LTE cell B, the display section 14 may not display that the UE 10 is outside of the LTE cell B as shown, for example, in FIG. 3B or may display that the UE 10 is outside of the LTE cell B as shown, for example, in FIG. 3C.

Furthermore, when the LTE cell B is recognized as the serving cell or when the serving cell is changed to the LTE cell B, the display section 14 may display that the UE 10 is in the coverage of LTE cell B as shown, for example, in FIG. 3A.

The instruction accepting section 15 receives a display instruction from the user as to whether or not the UE 10 is in the coverage of LTE cell B. Upon receiving the display instruction, the instruction accepting section 15 requests the estimation section 13 to estimate whether or not the UE 10 is in the coverage of LTE cell B.

### <Operation of Mobile Communication System>

Next, operation of the mobile communication system 1 configured as shown above will be described.

### (1) Operation of UE 10

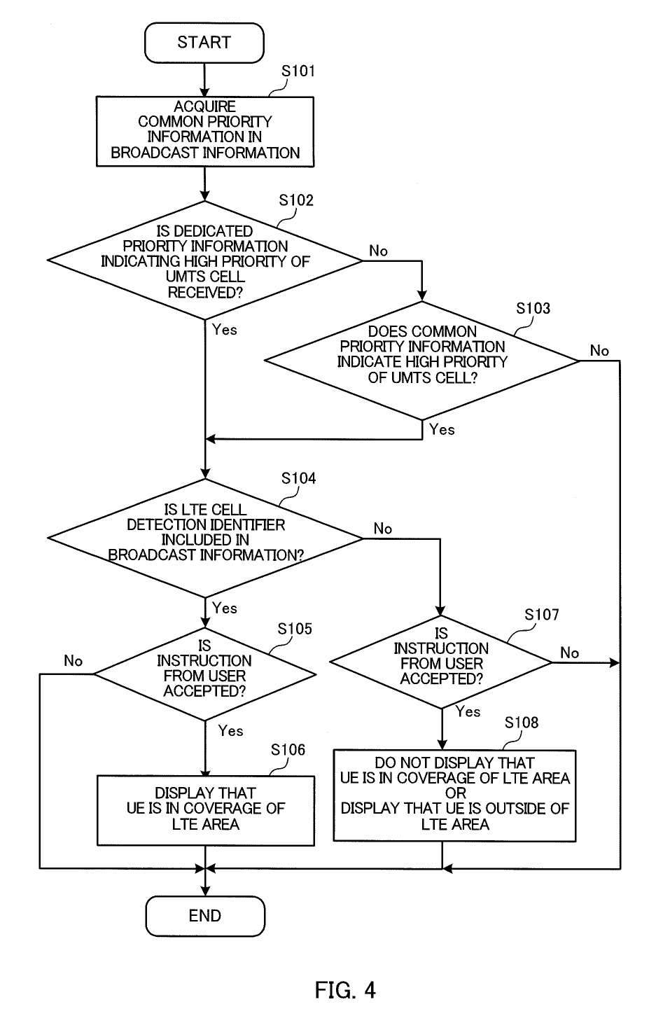

First, when the LTE cell B has lower priority than the UMTS cell A, operation of the UE 10 which recognizes the UMTS cell A as the serving cell will be described. FIG. 4 is a flowchart illustrating the operation of the UE according to the first embodiment of the present invention.

As shown in FIG. 4, the radio communication section 11 of the UE 10 receives broadcast information broadcast from the RNC 30 and the priority determining section 12 acquires common priority information included in the received broadcast information (step S101). The priority determining section 12 determines whether or not the radio communication section 11 receives dedicated priority information indicating that the LTE cell B has lower priority than the UMTS cell A (step S102).

When the dedicated priority information indicating that the LTE cell B has lower priority than the UMTS cell A is received (step S102; Yes), the priority determining section 12 determines that the LTE cell B has lower priority than the UMTS cell A in accordance with the dedicated priority information and the present operation moves to step S104.

On the other hand, when the dedicated priority information indicating that the LTE cell B has lower priority than the UMTS cell A is not received (step S102; No), the priority determining section 12 determines whether or not the LTE cell B has lower priority than the UMTS cell A according to the common priority information acquired in step S101 (step S103).

When the priority determining section 12 determines that the LTE cell B has lower priority than the UMTS cell A according to the common priority information (step S103; Yes), the present operation moves to step S104. On the other hand, when the priority determining section 12 determines that the LTE cell B has higher priority than the UMTS cell A according to the common priority information (step S103; No), the present operation ends.

When the LTE cell B is determined to have lower priority than the UMTS cell A (step S102; Yes or step S103; Yes), the estimation section 13 determines whether or not the broadcast information received by the radio communication section 11 includes the LTE cell detection identifier (step S104).

When the broadcast information received by the radio communication section 11 includes the LTE cell detection identifier (step S104; Yes), the estimation section 13 estimates that the UE 10 is in the coverage of LTE cell B, and determines whether or not the instruction accepting section 15 has accepted a display instruction from the user as to whether or not the UE 10 is in the coverage of LTE cell B (step S105).

When the instruction accepting section 15 has accepted the display instruction (step S105; Yes), the display section 14 displays that the UE 10 is in the coverage of LTE cell B according to the estimation result of the estimation section 13 as shown, for example, in FIG. 3A (step S106). Such a display allows the user of the UE 10 to recognize that an application specialized for the LTE scheme is available and that a large-volume content can be downloaded.

On the other hand, when the instruction accepting section 15 does not accept the display instruction (step S105; No), the display section 14 does not perform the display operation and the present operation ends. Step S105 is omissible and the display section 14 may display that the UE 10 is in the coverage of LTE cell B according to the estimation result of the estimation section 13 regardless of whether or not the instruction accepting section 15 has accepted the display instruction.

When the broadcast information received by the radio communication section 11 does not include any LTE cell detection identifier (step S104; No), the estimation section 13 estimates that the UE 10 is outside of the LTE cell B and determines whether or not the instruction accepting section 15 has accepted the display instruction from the user as to whether or not the UE 10 is in the coverage of LTE cell B (step S107).

When the instruction accepting section 15 has accepted the display instruction (step S107; Yes), the display section 14 does not display that the UE 10 is in the coverage of LTE cell B according to the estimation result of the estimation section 13 as shown, for example, in FIG. 3B or displays that the UE 10 is outside of the LTE cell B as shown in FIG. 3C (step S108).

On the other hand, when the instruction accepting section 15 does not accept the display instruction (step S107; No), the display section 14 does not perform the display operation and the present operation ends. Step S107 is omissible and the display section 14 may display that the UE 10 is outside of the LTE cell B according to the estimation result of the estimation section 13 regardless of whether or not the instruction accepting section 15 has accepted the display instruction.

Thus, the estimation section 13 estimates whether or not the UE 10 is in the coverage of LTE cell B depending on whether or not the broadcast information includes the LTE cell detection identifier and the display section 14 can display whether or not the UE 10 is in the coverage of LTE cell B according to the estimation result of the estimation section 13. Therefore, even when the radio environment in the UMTS cell A which is the serving cell is good and the serving cell need not be changed to the LTE cell, it is not necessary to perform any lower priority cell search which is a cell search of the LTE cell B having lower priority than the UNITS cell A only for the purpose of displaying that the UE 10 is in the coverage of LTE cell on a standby screen, and it is possible to reduce processing load or power consumption of the mobile terminal.

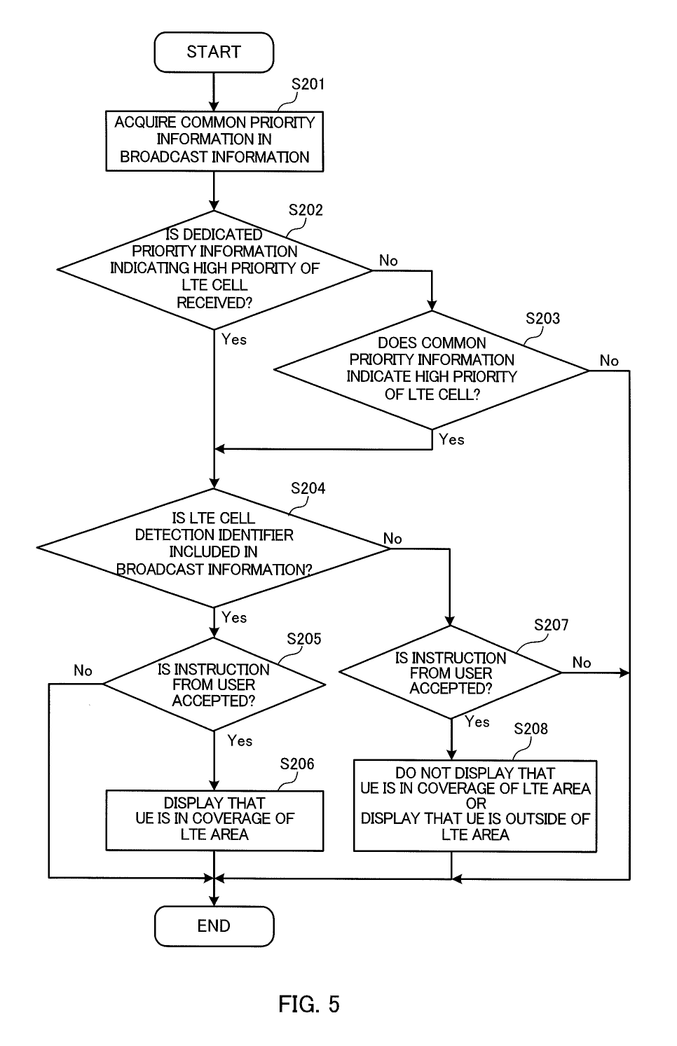

Second, when the LTE cell B has higher priority than the UMTS cell A, operation of the UE 10 which recognizes the UMTS cell A as the serving cell will be described. FIG. 5 is a flowchart illustrating the operation of the UE according to the first embodiment of the present invention.

As shown in FIG. 5, the radio communication section 11 of the UE 10 receives broadcast information broadcast from the RNC 30 and the priority determining section 12 acquires common priority information included in the received broadcast information (step S201). The priority determining section 12 determines whether or not the radio communication section 11 receives dedicated priority information indicating that the LTE cell B has higher priority than the UMTS cell A (step S202).

When the dedicated priority information indicating that the LTE-cell B has higher priority than the UMTS cell A is received (step S202; Yes), the priority determining section 12 determines that the LTE cell B has higher priority than the UMTS cell A in accordance with the dedicated priority information and the present operation moves to step S204.

On the other hand, when the dedicated priority information indicating that the LTE cell B has higher priority than the UMTS cell A is not received (step S202; No), the priority determining section 12 determines whether or not the LTE cell B has higher priority than the UMTS cell A according to the common priority information acquired in step S202 (step S203).

When the priority determining section 12 determines that the LTE cell B has higher priority than the UMTS cell A according to the common priority information (step S203; Yes), the present operation moves to step S204. On the other hand, when the priority determining section 12 determines that the LTE cell B has lower priority than the UMTS cell A according to the common priority information (step S203; No), the present operation ends.

When it is determined that the LTE cell B has higher priority than the UMTS cell A (step S202; Yes or step S203; Yes), the estimation section 13 determines whether or not the broadcast information received by the radio communication section 11 includes an LTE cell detection identifier (step S204).

When the broadcast information received by the radio communication section 11 includes the LTE cell detection identifier (step S204; Yes), the estimation section 13 estimates that the UE 10 is in the coverage of LTE cell B, and determines whether or not the instruction accepting section 15 has accepted a display instruction from the user as to whether or not the UE 10 is in the coverage of LTE cell B (step S205).

When the instruction accepting section 15 has accepted the display instruction (step S205; Yes), the display section 14 displays that the UE 10 is in the coverage of LTE cell B according to the estimation result of the estimation section 13 as shown, for example, in FIG. 3A (step S206). Such a display allows the user of the UE 10 to recognize that an application specialized for the LTE scheme is available and that a large-volume content can be downloaded.

On the other hand, when the instruction accepting section 15 does not accept any display instruction (step S205; No), the display section 14 does not perform any display operation, and the present operation ends. Step S205 is omissible and the display section 14 may display that the UE 10 is in the coverage of LTE cell B according to the estimation result of the estimation section 13 regardless of whether or not the instruction accepting section 15 has accepted the display instruction.

When the broadcast information received by the radio communication section 11 does not include any LTE cell detection identifier (step S204; No), the estimation section 13 estimates that the UE 10 is outside of the LTE cell B and determines whether or not the instruction accepting section 15 has accepted the display instruction from the user as to whether or not the UE 10 is in the coverage of LTE cell B (step S207).

When the instruction accepting section 15 has accepted the display instruction (step S207; Yes), the display section 14 does not display that the UE 10 is in the coverage of LTE cell B according to the estimation result of the estimation section 13 as shown, for example, in FIG. 3B or displays that the UE 10 is outside of the LTE cell B as shown in FIG. 3C (step S208).

On the other hand, when the instruction accepting section 15 has not accepted the display instruction (step S207; No), the display section 14 does not perform the display operation and the present operation ends. Step S207 is omissible, and the display section 14 may display that the UE 10 is outside of the LTE cell B according to the estimation result of the estimation section 13 regardless of whether or not the instruction accepting section 15 has accepted the display instruction.

Thus, the estimation section 13 estimates whether or not the UE 10 is in the coverage of LTE cell B depending on whether the broadcast information includes the LTE cell detection identifier and the display section 14 can display whether or not the UE 10 is in the coverage of LTE cell B according to the estimation result of the estimation section 13. Therefore, even when the radio environment in the UMTS cell A which is the serving cell is good and the serving cell need not be changed to the LTE cell, there is no need to perform any higher priority cell search which is a cell search of the LTE cell B having higher priority than the UMTS cell A for only the purpose of displaying that the UE 10 is in the coverage of LTE cell on the standby screen, and it is possible to reduce the processing load and power consumption of the mobile terminal.

### (2) Display Control Operation According to Common Priority Information

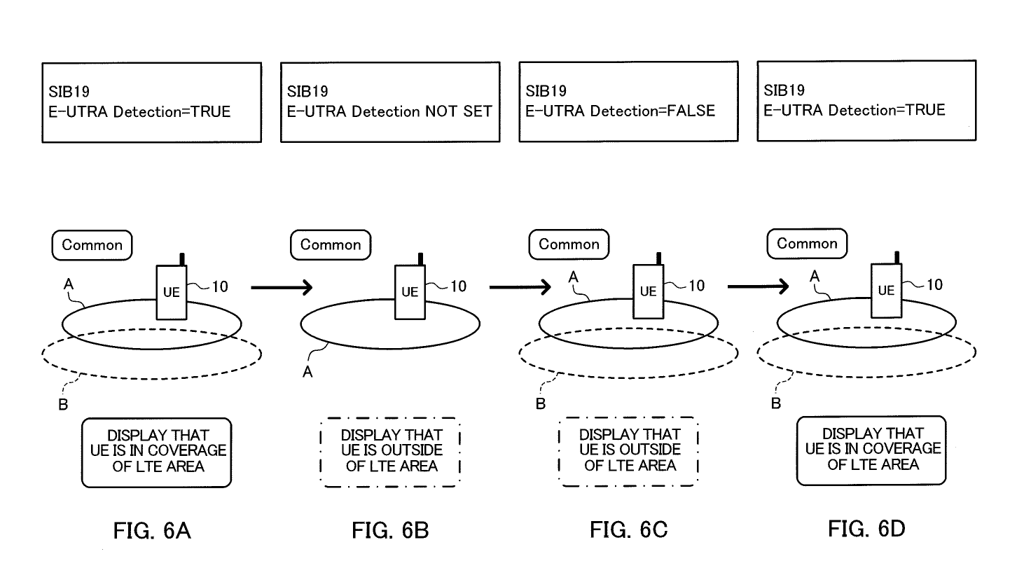

FIG. 6 is a diagram illustrating a display control operation in accordance with the common priority information according to the first embodiment of the present invention. In FIG. 6, suppose the UE 10 recognizes the UMTS cell A as the serving cell. Furthermore, suppose the priority determining section 12 of the UE 10 determines that the LTE cell B has lower priority than the UMTS cell A in accordance with the common priority information included in the broadcast information from the RNC 30.

In FIG. 6, description will be given assuming that the broadcast information broadcast from the RNC 30 is “SIB19” and the LTE cell detection identifier is “E-UTRA Detection” set to “TRUE.”

In FIGS. 6A and 6D, “SIB19” broadcast from the RNC 30 includes “E-UTRA Detection” set to “TRUE.” For this reason, the estimation section 13 of the UE 10 estimates that the UE 10 is in the coverage of LTE cell B without performing any lower priority cell search of the LTE cell B having lower priority than the UMTS cell A which is the serving cell. Furthermore, as shown in FIG. 3A, the display section 14 displays that the UE 10 is in the coverage of LTE cell B.

On the other hand, in FIG. 6B, “SIB19” broadcast from the RNC 30 does not include the information element of “E-UTRA Detection” itself. For this reason, the estimation section 13 of the UE 10 estimates that the UE 10 is outside of the LTE cell B without performing the above-described lower priority cell search. Furthermore, the display section 14 may not display that the UE 10 is in the coverage of LTE cell B as shown in FIG. 3B and may display that the UE 10 is outside of the LTE cell B as shown in FIG. 3C.

Furthermore, in FIG. 6C, “SIB19” broadcast from the RNC 30 includes “E-UTRA Detection” set to “FALSE.” For this reason, the estimation section 13 of the UE 10 estimates that the UE 10 is outside of the LTE cell B without performing the above-described lower priority cell search. Furthermore, the display section 14 may not display that the UE 10 is in the coverage of LTE cell B as shown in FIG. 3B and may display that the UE 10 is outside of the LTE cell B as shown in FIG. 3C. Such a situation occurs when the LTE cell B exists but the network operator does not want to report to the user that the UE 10 is in the coverage of LTE cell B.

The above-described display control operation is also applicable to a case where the priority determining section 12 of the UE 10 determines that the LTE cell B has higher priority than the UMTS cell A in accordance with the common priority information included in the broadcast information from the RNC 30. In such a case, the estimation section 13 can estimate whether or not the UE 10 is in the coverage of LTE cell B without performing any higher priority cell search of the LTE cell B having higher priority than the UMTS cell A which is the serving cell and the display section 14 can display whether or not the UE 10 is in coverage of the LTE cell B.

(3) Display Control Operation in Accordance with Dedicated Priority Information

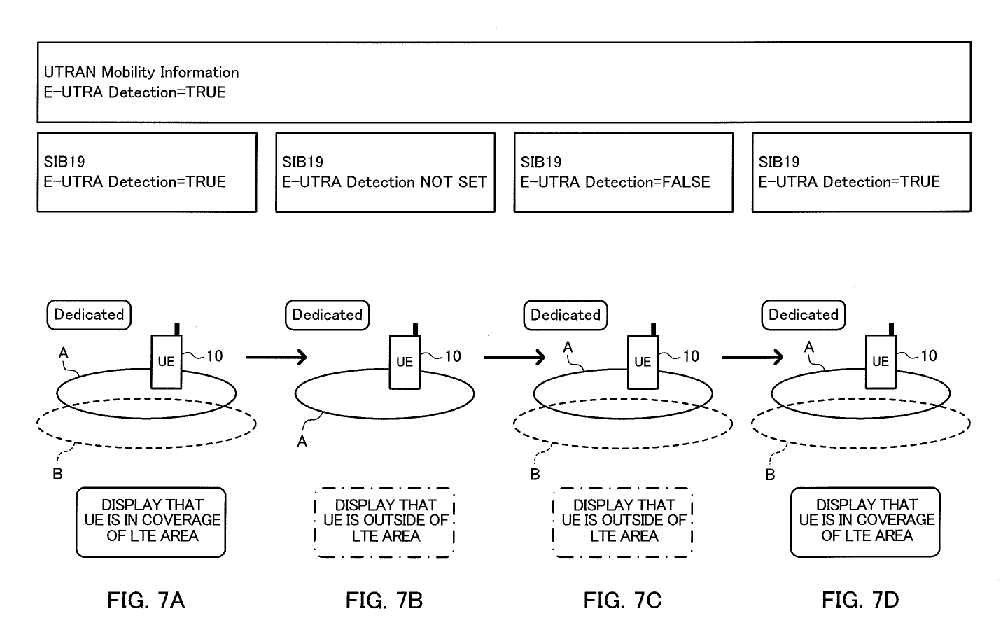

FIG. 7 is a diagram illustrating a display control operation in accordance with dedicated priority information in the mobile communication system according to the first embodiment of the present invention. In FIG. 7, suppose the UE 10 recognizes the UMTS cell A as the serving cell. Furthermore, the radio communication section 11 of the UE 10 receives broadcast information broadcast from the RNC 30 in FIGS. 7A to 7D and receives dedicated priority information dedicatedly provided from the RNC 30 in FIG. 7A. Furthermore, suppose the priority determining section 12 in FIGS. 7A to 7D determines that the LTE cell B has lower priority than the UMTS cell A in accordance with the dedicated priority information provided in FIG. 7A.

In FIG. 7, description will be given assuming that the broadcast information broadcast from the RNC 30 is “SIB19,” the dedicated priority information dedicatedly provided from the RNC 30 is “UTRAN Mobility Information” and the LTE cell detection identifier is “E-UTRA Detection” set to “TRUE.”

In FIGS. 7A and 7D, “E-UTRA Detection” set to “TRUE” is included in both “UTRAN Mobility Information” and “SIB19.” For this reason, the estimation section 13 of the UE 10 estimates that the UE 10 is in the coverage of LTE cell B without performing the above-described lower priority cell search. Furthermore, the display section 14 displays that the UE 10 is in the coverage of LTE cell B as shown in FIG. 3A.

On the other hand, in FIG. 7B, “UTRAN Mobility Information” includes “E-UTRA Detection” set to “TRUE,” but “SIB19” does not include the information element of “E-UTRA Detection” itself. Such a state occurs because “UTRAN Mobility Information” is not updated whereas “SIB19” is updated as appropriate in accordance with the radio environment and the network situation.

In FIG. 7B, since “SIB19” does not include the information element of “E-UTRA Detection” itself, the estimation section 13 of the UE 10 estimates that the UE 10 is outside of the LTE cell B without performing the above-described lower priority cell search. Furthermore, the display section 14 may not display that the UE 10 is in the coverage of LTE cell B as shown in FIG. 3B or may display that the UE 10 is outside of the LTE cell B as shown in FIG. 3C. Through such display control, it is possible to prevent the UE 10 from being estimated to remain in the coverage of LTE cell B although the UE 10 has already moved outside the LTE cell B.

Furthermore, in FIG. 7C, “UTRAN Mobility Information” includes “E-UTRA Detection” set to “TRUE” and “SIB19” includes “E-UTRA Detection” set to “FALSE.” Such a state occurs when the LTE cell B exists but the network operator does not want to report to the user that the UE 10 is in the coverage of LTE cell B.

In FIG. 7C, since “SIB19” includes “E-UTRA Detection” set to “FALSE,” the estimation section 13 of the UE 10 estimates that the UE 10 is outside of the LTE cell B without performing the above-described lower priority cell search. Furthermore, as described above, the display section 14 need not display that UE 10 is in the coverage of LTE cell B as shown in FIG. 3B and may display that the UE 10 is outside of the LTE cell B as shown in FIG. 3C. Through such display control, it is possible to prevent the fact that the UE 10 is in the coverage of LTE cell B from being reported to the user against the desire of the network operator.

The above-described display control operation is also applicable to a case where the priority determining section 12 of the UE 10 determines that the LTE cell B has higher priority than the UMTS cell A in accordance with the dedicated priority information included in the broadcast information from the RNC 30. In such a case, the estimation section 13 can estimate whether or not the UE 10 is in the coverage of LTE cell B without performing the above-described higher priority cell search and the display section 14 can display whether or not the UE 10 is in the coverage of LTE cell B.

### <Operations/Effects>

According to the mobile communication system of the first embodiment, the UE 10 which recognizes the UMTS cell A as the serving cell can display that the UE 10 is in the coverage of LTE cell B on the standby screen only depending on whether or not the broadcast information includes an LTE cell detection identifier. Therefore, it is not necessary to perform any lower priority cell search of the LTE cell B having lower priority than the serving cell or a higher priority cell search of the LTE cell B having higher priority than the serving cell for only the purpose of displaying that the UE 10 is in the coverage of LTE cell B on the standby screen, and thereby prevent power consumption caused by the cell search from increasing.

Furthermore, according to the mobile communication system according to the first embodiment, even when common priority information is broadcast from the RNC 30 of the UMTS scheme and dedicated priority information is dedicatedly provided, the UE 10 can appropriately determine priority of the UMTS cell A and LTE cell B.

Furthermore, according to the mobile communication system according to the first embodiment, even when priority of the UMTS cell A and LTE cell B is determined based on the dedicated priority information dedicatedly provided to the UE 10, it is possible to estimate whether or not the UE 10 is in the coverage of LTE cell B depending on whether or not the broadcast information, which is appropriately updated according to the radio environment, network situation or the like, includes an LTE cell detection identifier. Therefore, it is possible to prevent the UE 10 from being estimated to be in the coverage of LTE cell B based on old dedicated priority information although the UE 10 has already moved to outside the LTE cell B.

Although the present invention has been described in detail using the above-described embodiment, it is obvious to those skilled in the art that the present invention is not limited to the embodiment described in the present DESCRIPTION.

For example, in the above-described embodiment, when the broadcast information received by the radio communication section 11 includes an LTE cell detection identifier, the UE 10 estimates that the own terminal is in the coverage of LTE cell B and displays that the UE 10 is in the coverage of LTE cell B without performing any cell search of the LTE cell B. However, when the broadcast information includes an LTE detection identifier, the UE 10 may perform a cell search of the LTE cell B and then display that the UE 10 is in the coverage of LTE cell B in accordance with the cell search result. To be more specific, the UE 10 may perform a cell search of the LTE cell B in step S106 of FIG. 4 and display that the UE 10 is in the coverage of LTE cell B when the LTE cell B is detected through the cell search. In such a case, when the broadcast information does not include any LTE detection identifier, the UE 10 does not perform any cell search of the LTE cell B, and can thereby reduce processing load or power consumption of the UE 10 compared to the case where a cell search is performed regardless of whether or not the LTE detection identifier is included. Furthermore, since the UE 10 displays that the UE 10 is in the coverage of LTE cell B when the LTE cell B is detected through the cell search, it is possible to improve the display accuracy as to whether or not the UE 10 is in the coverage of LTE cell B.

The present invention can be implemented as modified or altered embodiments without departing from the spirit and scope of the present invention defined in the description of the scope of patent claims. Therefore, the description of the present DESCRIPTION is intended to be illustrative and by no means intended to limit the present invention.

The present application is based on Japanese Patent Application No. 2010-081836 filed on Mar. 31, 2010, entire content of which is expressly incorporated by reference herein.

1. A mobile terminal configured to, in an overlapping area between a first cell capable of communication using a first scheme and a second cell capable of communication using a second scheme, recognize the first cell as a serving cell which the mobile terminal camps on or is connected to, comprising:
a receiving section configured to receive broadcast information broadcast from a network-side apparatus of the first scheme;
an estimation section configured to estimate that the mobile terminal is in a coverage of second cell, when the broadcast information received by the receiving section includes a second cell detection identifier; and
a display section configured to display that the mobile terminal is in the coverage of second cell, when the estimation section estimates that the mobile terminal is in the coverage of second cell.

2. The mobile terminal according to claim 1, further comprising
a priority determining section configured to determine priority of the first cell and the second cell,
wherein when the priority determining section determines that the second cell has lower priority than the first cell and when the broadcast information received by the receiving section includes the second cell detection identifier, the estimation section is configured to estimate that the mobile terminal is in the coverage of second cell.

3. The mobile terminal according to claim 2,
wherein when the priority determining section determines that the second cell has higher priority than the first cell and when the broadcast information received by the receiving section includes the second cell detection identifier, the estimation section is configured to estimate that the mobile terminal is in the coverage of second cell.

4. The mobile terminal according to claim 2,
wherein the receiving section is configured to receive not only the broadcast information but also dedicated priority information dedicatedly provided to the mobile terminal from the network-side apparatus of the first scheme, and
when the receiving section receives the dedicated priority information in addition to the broadcast information, the priority determining section is configured to determine the priority of the first cell and the second cell in accordance with the dedicated priority information.

5. The mobile terminal according to claim 4,
wherein when the priority determining section determines that the second cell has lower priority than the first cell in accordance with the dedicated priority information and even when the dedicated priority information includes the second cell detection identifier, if the broadcast information does not include the second cell detection identifier, the estimation section is configured to estimate that the mobile terminal is outside of the second cell.

6. The mobile terminal according to claim 1,
wherein the broadcast information is an SIB (System Information Block Type) 19, and the second cell detection identifier is E-UTRA Detection set to TRUE.

7. A mobile communication method comprising the steps of:
by a mobile terminal configured to, in an overlapping area between a first cell capable of communication using a first scheme and a second cell capable of communication using a second scheme, recognize the first cell as a serving cell which the mobile terminal camps on or is connected to, receiving broadcast information broadcast from a network-side apparatus of the first scheme;
estimating that the mobile terminal is in a coverage of second cell, when the received broadcast information includes a second cell detection identifier; and
displaying that the mobile terminal is in the coverage of second cell, when the mobile terminal is estimated to be in the coverage of second cell.

8. The mobile terminal according to claim 3,
wherein the receiving section is configured to receive not only the broadcast information but also dedicated priority information dedicatedly provided to the mobile terminal from the network-side apparatus of the first scheme, and
when the receiving section receives the dedicated priority information in addition to the broadcast information, the priority determining section is configured to determine the priority of the first cell and the second cell in accordance with the dedicated priority information.
